(19) United States
(12) Patent Application Publication
(10) Pub. No.: US 2025/0014034 A1
(43) Pub. Date: Jan. 9, 2025

(54) Method for establishing a transaction between a communicating object and a transaction control module associated with a device for providing one or more products or services

(71) Applicant: ORANGE, ISSY LES MOULINEAUX (FR)

(72) Inventors: Emmanuel Le Huerou, Chatillon Cedex (FR); François Toutain, Chatillon Cedex (FR)

(21) Appl. No.: 18/711,345

(22) PCT Filed: Nov. 3, 2022
(86) PCT No.: PCT/FR2022/052072

§ 371 Date: May 17, 2024

(30) Foreign Application Priority Data
Nov. 26, 2021 (FR) 2112578

(51) Int. Cl. G06Q 20/40; G06Q 20/32

(52) U.S. Cl. CPC G06Q 20/401; G06Q 20/325

(57) ABSTRACT

A method for establishing a transaction using a communicating object in which the object receives a request containing data relating to the transaction from a device for providing a product or a service or from a transaction control module associated with the device. The object carries out the following: receiving, from the module or the device, a message asking whether a reader of a means for accessing a service for implementing the transaction is associated with the object; a reader being associated with the object, reading identification data of a means for accessing the service, using the reader; and transmitting the identification data to the module to validate the transaction.

### FIELD OF THE INVENTION

The invention relates in general to the field of technologies used to implement transactions such as for example banking transactions carried out in the context of payment services that use contact-based or contactless payment terminals, access control transactions carried out in the context of access services, for example access to a means of transport or to a secure location, which use contact-based or contactless access control terminals, etc. Such terminals are configured to accept a means of access to the service implementing a transaction. In the context of a banking transaction for example, such a means of access is able to communicate, for example in a contact-based manner, with the payment terminal, said means of access typically being a bank chip card, or is able to communicate contactlessly with the payment terminal, said means of access then typically being a contactless bank card, for example an NFC (near-field communication) bank card, a mobile telephone equipped with an NFC device, etc. Similarly, in the context of an access control transaction, such a means of access is able to communicate, for example in a contact-based manner, with the access control terminal, said means of access typically being a badge or a chip card, or is able to communicate contactlessly with the access control terminal, said means of access then typically being an NFC card or badge, a mobile telephone equipped with an NFC device, etc.

More precisely, the invention relates to pairing between a communication terminal of the abovementioned type and a communicating object equipped with a means of access to a transaction service of the abovementioned type, such a communicating object being for example a connected vehicle, a smartphone, a connected watch, etc.

### PRIOR ART

At present, to pay for a product or service using a communicating object of the abovementioned type, it is necessary to physically approach a means of payment reader associated with the payment terminal, so that the reader is able to read the means of payment used, be this contactless or contact-based.

Thus, when the communicating object is for example a smartphone used as a means of payment, the user of the smartphone wishing to interact with an accessible payment terminal of the provider of the product or service to be paid for is systematically obliged to carry out certain actions to bring their smartphone close to the reader of the payment terminal. Such actions become complicated when the user is an occupant in a vehicle, for example the driver, the user being obliged to:
either leave the vehicle, for example when the payment terminal is integrated into a petrol pump machine for example,
or lower the window of their vehicle to interact with an electronic payment terminal (EPT) that is arranged or manipulated so as to be accessible to the driver user (for example, a motorway toll payment terminal; a merchant EPT attached to the counter or held out by the attendant when paying for a product or service at a drive-in (open-air cinema, take-out, etc.).

Such interactions with payment terminals have the following drawbacks:
lack of ergonomics, since it is sometimes necessary to leave the vehicle to present one's means of payment, or to maneuver the vehicle accurately enough to then be able to reach the EPT (failing which it is necessary to be able to open the door to leave and access the EPT with difficulty),
lack of security, since a payment machine situated in a public space is able to be observed with a view to intercepting a secret code, for example, and is able to be hacked more easily by a malicious person with a view to intercepting secrets exchanged during the transaction.

This lack of ergonomics and security is also observed in the case of an access control service. Specifically, in the case for example of accessing a bus or a tram, it is sometimes difficult, particularly in the case of crowds or for a person with reduced mobility, to access the reader of the access control terminal, which is generally installed in the bus or tram, in order to present one's transport card and thus validate one's journey. And since public transport is involved, the abovementioned hacking may also be implemented in a manner similar to a payment service.

Moreover, taking into account the fact that the communication terminals used to implement a transaction of the abovementioned type are hardware-based and integrate or are associated with a reader for reading means of access to a transaction service, these terminals represent significant costs for product or service providers in terms of investment, maintenance, replacement, troubleshooting, degradation, etc.

### AIM AND SUMMARY OF THE INVENTION

One of the aims of the invention is to rectify drawbacks of the abovementioned prior art by enabling a communicating or connected object to carry out a transaction using a means of access to the service in which the transaction is implemented, in the absence of any physical terminal for controlling the transaction, such as an EPT payment terminal, a hardware-based access control device associated with a terminal or with a gate for access to a means of transport or to a secure or non-secure location, etc.

To this end, one subject of the present invention relates to a method for establishing a transaction using a communicating object in order to implement provision of a product or service to a user, in the course of which the communicating object receives a request containing data relating to the transaction from a device for providing the product or service or from a transaction control module associated with the device.

Such a method is noteworthy in that the communicating object implements the following:
receiving, from the module or from the device, a message asking whether a reader for reading a means of access to a service implementing the transaction is associated with the communicating object,
if a reader is associated with the communicating object, reading identification data of a means of access to said service, using the reader,
transmitting the read identification data to the software-based transaction control module in order to validate the transaction.

The invention advantageously proposes to implement communication between a reader associated with the communicating object and a transaction control module associated with the provider of the product or service, thereby allowing the provider of the product or service to dispense with a physical terminal equipped with a reader and configured to accept a means of access to the service implementing a transaction, which is far less expensive for this provider. Thus, for example, in a banking transaction, the invention makes it possible to construct, on the fly, an EPT payment terminal for which the software portion that processes the payment is associated with the device for providing the product or service (for example a fuel pump, a take-out kiosk, etc.), and the portion that deals with reading a contact-based or contactless means of payment is associated with the communicating object. According to another example, in the case of an access control transaction, it is possible to construct, on the fly, an access terminal for which the software portion that processes the access authorization is associated with the device for providing the product or service (for example a bus, an access gate to a library, a barrier for accessing a parking lot, etc.), and the portion that deals with reading a contact-based or contactless means of access is associated with the communicating object. Moreover, the transaction is far easier for the user to implement than in the prior art, since it is no longer necessary for the user to move toward the reader in order to implement the transaction, given that this reader is associated with the communicating object with which the user is equipped.

According to one particular embodiment, before the reading step, the method implements a step of mutual authentication between the reader associated with the communicating object and the transaction control module.

Such mutual authentication is tantamount to advantageously carrying out, upon each transaction, dynamic pairing between the reader on the communicating object side and the software-based transaction control module instantiated on the product or service provider side. The transaction is thus far more flexible for the user than in the prior art, since the communicating object that they possess is associated with a generic reader that is configured to read various types of means of access to a service implementing a transaction, such as payment cards, transport tickets, etc. and that is able to operate independently of the type of product or service provider (a service station, a take-out point of sale, a private parking lot, etc.), by virtue of this dynamic pairing with a transaction control module associated with the device for providing the product or service, and not with this device itself.

According to another particular embodiment, the method for establishing a transaction according to the invention comprises the following, at the reader associated with the communicating object, during the execution of said authentication step:
receiving, from the transaction control module, an identifier of said module,
checking the validity of the identifier,
if the identifier is valid, transmitting an identifier of the reader to the transaction control module,
if the identifier of said reader has been recognized as valid by the transaction control module, mutually authenticating the reader and the transaction control module.

In this embodiment, it is the transaction control module on the product or service provider side that initiates the pairing with the reader associated with the communicating object.

According to another particular embodiment, the method for establishing a transaction according to the invention comprises the following, at the reader associated with the communicating object, during the execution of the authentication step:
transmitting an identifier of the reader to the transaction control module,
if the identifier of the reader has been recognized as valid by the transaction control module, receiving, from the module, a message containing an identifier of the module,
checking the validity of the identifier of the module,
if the identifier of the module is valid, mutually authenticating the reader and the transaction control module.

In this embodiment, it is the reader on the communicating object side that initiates the pairing with the transaction control module on the product or service provider side. According to another particular embodiment, the identifier of the reader as well as the identifier of the transaction control module are transmitted using an encryption mechanism.

Such an embodiment makes it possible to optimize the security of the pairing between the reader on the communicating object side and the transaction control module on the product or service provider side.

The various abovementioned embodiments or implementation features may be added, independently or in combination with one another, to the method for establishing a transaction defined above.

The invention also relates to a communicating object for establishing a transaction implementing provision of a product or service to a user, said communicating object comprising a processor that is configured to receive a request containing data relating to the transaction from a device for providing the product or service or from a transaction control module associated with said device.

Such a communicating object is noteworthy in that the processor of the communicating object implements the following:
receiving, from the module or from the device, a message asking whether a reader for reading a means of access to a service implementing the transaction is associated with the communicating object,
if a reader is associated with the communicating object, reading identification data of a means of access to the service, using the reader,
transmitting the read identification data to the software-based transaction control module in order to validate the transaction.

The invention also relates to a system for establishing a transaction.

Such a system is noteworthy in that it comprises:
a communicating object implementing the abovementioned method for establishing a transaction,
a transaction control module that is associated with a device for providing one or more products or services.

The invention also relates to a computer program comprising instructions for implementing the method for establishing a transaction according to the invention, according to any one of the particular embodiments described above, when said program is executed by a processor.

Such instructions may be stored durably in a non-transient memory medium of the communicating object implementing the method for establishing a transaction according to the invention.

This program may use any programming language and be in the form of source code, object code or intermediate code between source code and object code, such as in a partially compiled form, or in any other desirable form.

The invention also targets a computer-readable recording medium or information medium comprising instructions of a computer program as mentioned above. The recording medium may be any entity or device capable of storing the program. For example, the medium may comprise a storage means, such as a ROM (read-only memory), for example a CD-ROM (compact disc read-only memory) or a microelectronic circuit ROM, or else a magnetic recording means, for example a mobile medium, a hard drive or an SSD (solid-state drive).

Furthermore, the recording medium may be a transmissible medium such as an electrical or optical signal, which may be routed via an electrical or optical cable, by radio or by other means, such that the computer program that it contains is able to be executed remotely. The program according to the invention may in particular be downloaded from a network, for example an Internet network.

As an alternative, the recording medium may be an integrated circuit in which the program is incorporated, the circuit being designed to execute or to be used in the execution of the abovementioned method for establishing a transaction.

According to one exemplary embodiment, the present technique is implemented by way of software components and/or hardware components. With this in mind, the term “module” may correspond in this document equally to a software component, to a hardware component or to a set of software components and hardware components.

### BRIEF DESCRIPTION OF THE DRAWINGS

Other features and advantages will become apparent on reading particular embodiments of the invention, which are given by way of illustrative and non-limiting examples, and the appended drawings, in which:

FIG. 1 shows one example of an architecture in which the method for establishing a transaction according to the invention is implemented,

FIG. 2 shows a communicating object in one embodiment of the invention,

FIG. 3 shows the main actions implemented in the method for establishing a transaction, according to one particular embodiment of the invention,

FIG. 4A shows one embodiment of an authentication step implemented in the method for establishing a transaction according to the invention,

FIG. 4B shows another embodiment of an authentication step implemented in the method for establishing a transaction according to the invention,

FIG. 5A shows a system for establishing a transaction according to a first embodiment of the invention,

FIG. 5B shows a system for establishing a transaction according to a second embodiment of the invention,

FIG. 5C shows a system for establishing a transaction according to a third embodiment of the invention.

### DETAILED DESCRIPTION OF EMBODIMENTS OF THE INVENTION

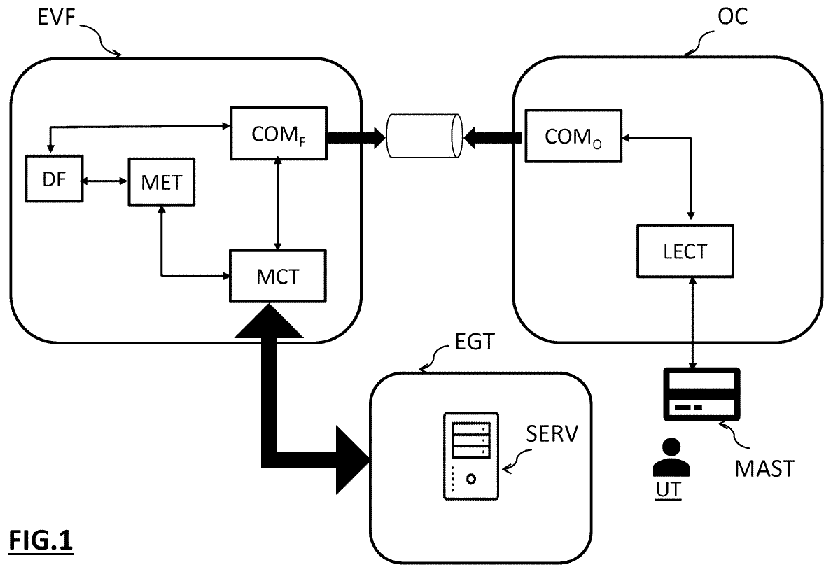

With reference to FIG. 1, a description is given of one example of an architecture in which the method for establishing a transaction according to the invention is implemented. According to this architecture, a system for establishing a transaction comprises:
a connected or communicating object OC associated with a user UT,
an environment EVF for providing one or more products or services to the user UT. Communicating or connected object OC is the name given to any object configured to capture data and to communicate with other objects or with dedicated infrastructures using IoT (Internet of Things) technology.

According to the invention, such a communicating object OC comprises a short-range or medium-range wireless radio communication module COMo, such as for example Bluetooth, LTE (Long-Term Evolution), Wi-Fi, DSRC (Dedicated Short-Range Communication), C-V2X (Cellular Vehicle to Everything), etc.

Particularly advantageously, the communicating object OC is associated with a reader LECT that is configured to read identification data of a means MAST of access to a service implementing the transaction. The means of access MAST may be a physical medium carried or worn by the user UT (for example bank card, transport badge, parcel delivery label, etc.) or a software-based medium integrated into the communicating object OC (for example dematerialized payment card, dematerialized transport ticket, electronic wallet, etc.). The reader LECT is also configured to communicate with the communication module COMo.

The environment EVF for providing one or more products or services for its part comprises, in a manner corresponding to the communicating object OC, a short-range or medium-range wireless radio communication module COM_{F}, such as for example Bluetooth, LTE, Wi-Fi, DSRC, C-V2X, etc.

The environment EVF furthermore comprises:
a device DF for providing a product or service to the user UT,
a transaction recording and processing module MET for providing one or more products or services,
a transaction control module MCT associated with the device DF for providing one or more products or services.

The transaction control module MCT is associated with the device DF for providing one or more products or services and/or with the transaction recording and processing module MET, in the sense that it may be integrated into the device DF for providing one or more products or services or into the transaction recording and processing module MET, or located in a virtualization environment made available to the provider of the product or service by a telecommunications operator, for example using MEC (Mobile Edge Computing) technology.

The transaction control module MCT, the device DF for providing one or more products or services and the transaction recording and processing module MET are configured to communicate with one another.

The transaction control module MCT is also configured to communicate, using any suitable type of communication and via the transaction recording and processing module MET, with a transaction management environment EGT that, in the example shown, is symbolized by a transaction management server SERV. Of course, multiple networked servers may be involved depending on the type of transaction implemented.

### Description of One Embodiment of the Communicating Object OC

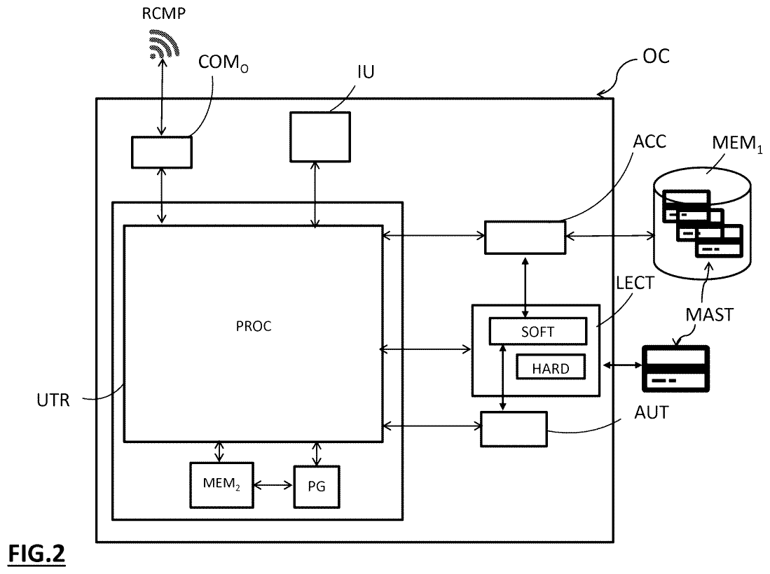

FIG. 2 shows the simplified structure of the communicating object OC configured to implement the method for establishing a transaction that will be described below. Such a communicating object comprises, according to the invention:
a communication module COMO designed to communicate, via a short-range or medium-range wireless data network RCMP, such as for example Bluetooth, NFC, LTE, Wi-Fi, DSRC, C-V2X, etc.,
a user interface IU configured to receive information from the user UT or to render information to the user in textual, visual and/or acoustic form: it may be for example a display screen, a keypad and/or a loudspeaker integrated into the communicating object OC,
a reader LECT of the abovementioned type, which comprises:
   a hardware portion HARD, such as for example an opening able to receive a means of access MAST, as well as possibly a keypad or an interface with the keypad of the user interface IU, or else a contactless communication surface, for example of NFC type,
   a software portion SOFT able to communicate with:
      an authentication module AUT that is configured to authenticate the transaction control module MCT of the environment EVF for providing one or more products or services with which the communicating object OC wishes to implement the transaction,
      a module ACC for access to a memory MEM₁ that contains identification data of means of access MAST to a service implementing the transaction, in the case where such means are envisaged in digital or dematerialized form.

By way of non-exhaustive examples, the software portion SOFT of the reader LECT may be:
a secure element: this secure element may be in the form for example of an eSIM (Embedded Subscriber Identification Module), which is provided by a telecommunications operator or the manufacturer of the communicating object OC;
a secure application, for example of SAM (Secured Applications for Mobile) type proposed by the GSM Association (Global System for Mobile Communications). The reader LECT is associated with the communicating object OC in the sense that the portion HARD of the reader LECT may be integrated into the communicating object OC or be an autonomous portion that is connected to the communicating object OC by any suitable wired or wireless connection means.

In FIG. 2, the memory MEM₁ is not necessarily contained within the communicating object OC in order to preserve the memory resources thereof. To this end, the memory MEM₁ may be transferred to a secure communication network, a secure cloud, etc. and is made accessible to the communicating object OC by way of the module ACC dedicated for this purpose. As a variant, the memory MEM₁ or a portion thereof could be integrated into the communicating object OC.

According to one particular embodiment of the invention, the actions executed by the communicating object OC, in the context of implementing the method for establishing a transaction according to the present invention, are implemented by instructions of a computer program PG. For this purpose, the communicating object OC has the conventional architecture of a computer and comprises in particular a memory MEM₂, a processing unit UTR, equipped for example with a processor PROC, and driven by the computer program PG stored in memory MEM₂. The computer program PG comprises instructions for implementing the actions executed by the communicating object OC when the program is executed by the processor PROC, according to any one of the particular embodiments of the invention.

On initialization, the code instructions of the computer program PG are for example loaded into a RAM memory (not shown), before being executed by the processor PROC. The processor PROC of the processing unit UTR implements in particular the contactless communication actions via the module COMo, the actions of reading identification data of the means of access MAST via the reader LECT, and the authentication actions using the authentication module AUT.

### Description of One Embodiment of a Method for Establishing a Transaction

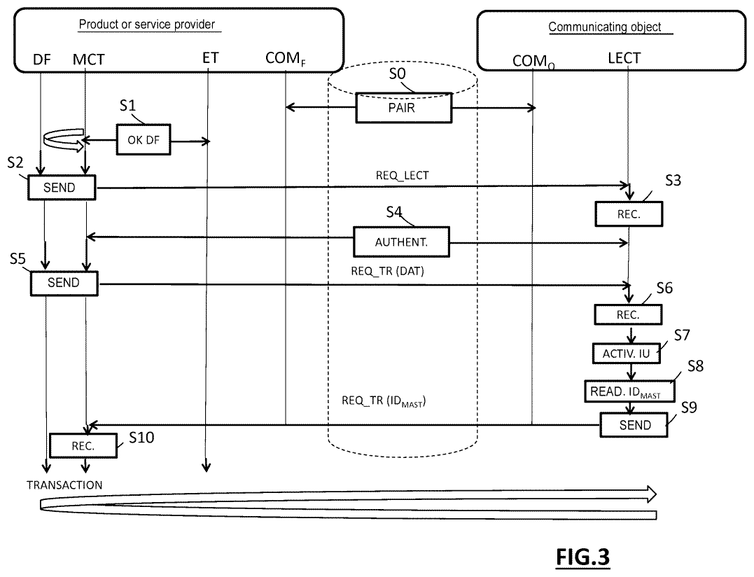

The sequence of a method for establishing a transaction executed by a communicating object OC, as illustrated in FIG. 2, is now described with reference to FIG. 3.

Such a transaction is established during prior contactless communication between the communicating object OC and the abovementioned device DF for providing one or more products or services. The subject of the transaction is for example a product or service provided by the device DF for providing one or more products or services to the user UT of the communicating object OC.

Prior to carrying out the method for establishing a transaction described below, it is considered that the user UT and their communicating object OC have moved toward the device DF for providing one or more products or services and that a communication channel has been established securely in SO to implement the transaction between the communicating object OC and the environment EVF for providing one or more products or services. Such a secure communication channel is established using the communication modules COM_{F} and COM_{O} illustrated in FIG. 1. The establishment of such a communication channel or pairing is conventional and will not be described further. In one particular embodiment, such a communication channel is established autonomously by the communicating object OC as described in document FR2106702, incorporated into the present description by reference. The method for establishing a transaction then takes place as follows.

In the environment EVF, the transaction control module MCT and/or the transaction recording and processing module MET check, in S1, that the device DF for providing one or more products or services is operational.

In S2, the transaction control module MCT or the device DF for providing one or more products or services sends, to the communicating object OC, via the secure channel established in S0, a request REQ_LECT asking whether the communicating object OC contains a reader LECT.

The communicating object OC receives the request REQ_LECT in S3.

If the communicating object OC contains such a reader LECT, mutual authentication is then executed in S4, via the authentication module AUT of FIG. 2, between the transaction control module MCT and the reader LECT. Such a step S4 is implemented depending on the more or less secure nature of the transaction. It is therefore optional. In the case of a payment transaction, step S4 is mandatory. For other types of transaction, for example access to a non-secure premises, step S4 may be optional.

In S5, the transaction control module MCT or the device DF for providing one or more products or services then sends, to the communicating object OC, via the secure channel established in S0, a request REQ_TR containing data DAT relating to a transaction. This may involve a message asking the user UT to present their means of access MAST to the reader LECT and/or a message containing the type of product and/or service, its value, its cost, etc.

The communicating object OC receives the request REQ_TR in S6.

In S7, the user interface IU is then activated in order to inform the user UT about the content of the data DAT and to ask the user UT to interact with the reader LECT, via an available means of access MAST.

In the course of this interaction, the reader LECT reads, in S8, identification data ID_{MAST} of the means of access MAST.

Such reading is implemented for example following contactless communication, for example NFC communication, between the means of access MAST and the reader LECT.

In another example, such reading is implemented following the insertion of the means of access MAST into a dedicated opening of the reader LECT and the possible entry by the user UT of a password MP by way of the keypad of the user interface IU or of the keypad integrated into the hardware portion HARD of the reader LECT.

According to yet another example, in the case where the means of access MAST is digital or dematerialized, such reading S8 is implemented following access, via the access module ACC of FIG. 2, to this means of access MAST, in the memory MEM₁ of the communicating object OC.

In S9, the communicating object OC sends, to the transaction control module MCT, via the secure channel established in S0, a response REP_TR to the request REQ_TR, said response REP_TR containing the identification data ID_{MAST} of the means of access MAST.

In S10, the transaction control module MCT receives the response REP_TR and the transaction is then validated in a conventional manner on the basis of the identification data ID_{MAST} of the means of access MAST that have been received, and in conjunction with the transaction management environment EGT, via the transaction recording and processing module MET.

By virtue of the method for establishing a transaction that has just been described above, the invention makes it possible, when a user UT in possession of a communicating object OC is in a transaction situation with an environment EVF for providing one or more products or services, to generate an assembly of a reader LECT for reading the means of access MAST, associated with the communicating object OC, with a transaction control module MCT that is available in the environment EVF for providing one or more products or services. Such an assembly has the effect of constructing a complete transaction terminal that makes it possible to carry out the transaction.

Particularly advantageously, such a reader LECT may be used to constitute a multitude of transaction terminals according to the transactions carried out by the user with various product or service providers. Symmetrically, the transaction control module MCT that is instantiated in a given environment EVF for providing one or more products or services may be assembled with a multitude of readers LECT that are presented by various users UT. The connection of a transaction control module MCT to various readers LECT may be simultaneous so as to enable the execution of transactions in parallel, which is not necessarily the case regarding the connection of a reader LECT to various transaction control modules MCT at the same time.

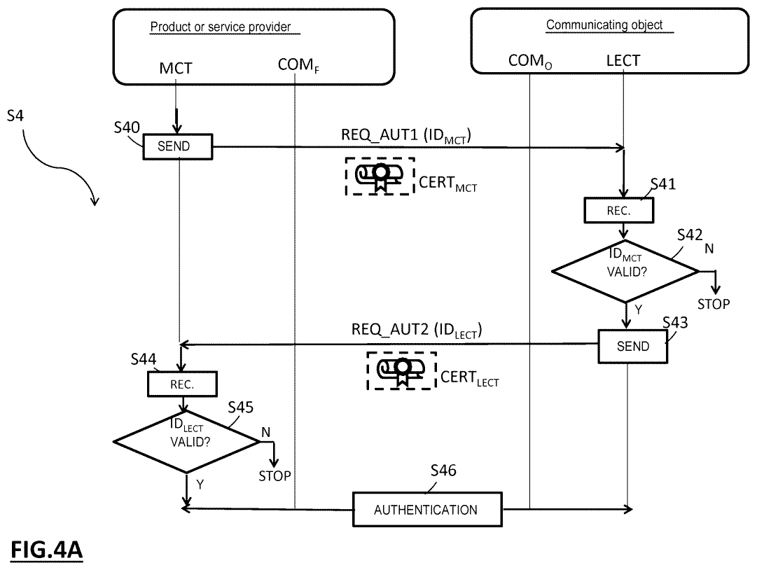

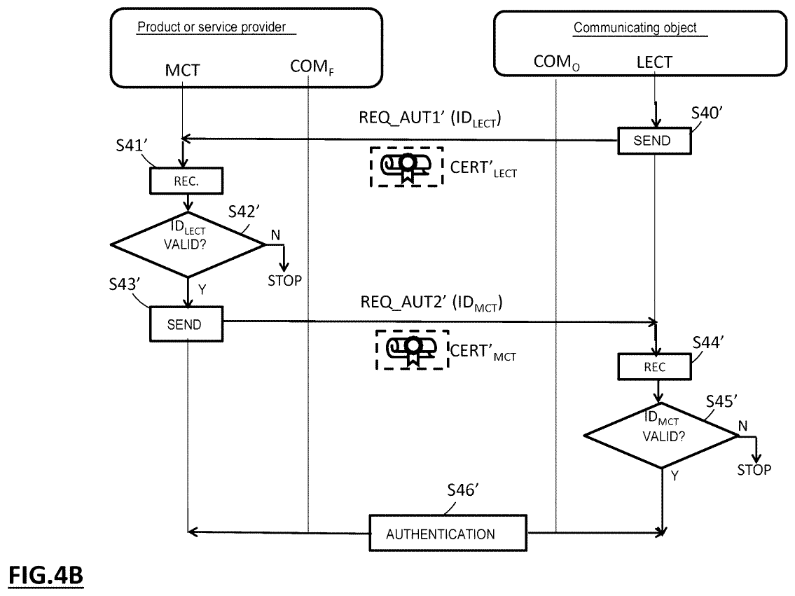

A description will now be given, with reference to FIG. 4A, of the abovementioned mutual authentication step S4, according to a first embodiment of the invention. In the example illustrated, authentication is requested at the initiative of the transaction control module MCT. The authentication step S4 then takes place as follows:

In S40, the transaction control module MCT sends, to the reader LECT, via the secure channel established in S0, an authentication request REQ_AUT1 that comprises an identifier ID_{MCT} of the module MCT.

The sending step S40 may be executed for example following receipt of a confirmation message from the reader LECT indicating that the communicating object OC has such a reader LECT. According to another embodiment, the request REQ_AUT1 could be transmitted at the same time as the request REQ_LECT sent in S2 (FIG. 3) asking whether the communicating object OC contains a reader LECT. The communicating object OC receives the request REQ_AUT1 in S41.

In S42, the reader LECT checks whether the received identifier ID_{MCT} is valid. If the received identifier ID_{MCT} is not valid, the authentication fails.

If the received identifier ID_{MCT} is valid, in S43, the reader LECT in turn sends, to the transaction control module MCT, via the secure channel established in S0, an authentication request REQ_AUT2 that comprises an identifier ID_{LECT} of the reader LECT.

The module MCT receives the request REQ_AUT2 in S44.

In S45, the module MCT checks whether the received identifier ID_{LECT} is valid. If the received identifier ID_{LECT} is not valid, the authentication fails.

If the received identifier ID_{LECT} is valid, in S46, mutual authentication between the module MCT and the reader LECT is established, thereby making it possible to constitute a transaction terminal distributed between the environment for providing one or more products or services and the communicating object OC.

When the security level of the transaction is low, in step S42 of checking the identifier ID_{MCT}, the reader LECT checks that this identifier belongs to a list of identifiers stored beforehand, for example in the memory MEM₁ of FIG. 2 or in any other suitable memory integrated into the communicating object OC or connected thereto. Correspondingly, in step S45 of checking the identifier ID_{LECT}, the module MCT checks that this identifier belongs to a list of identifiers stored beforehand in a memory (not shown) accessible to the module MCT in the environment EVF for providing one or more products or services.

When the security level of the transaction is high, the mutual authentication step S4 uses an encryption mechanism.

To this end:
in the course of the abovementioned sending step S40, the identifier ID_{MCT} of the module MCT is transmitted in a manner encrypted using an encryption key associated with a digital certificate CERT_{MCT};
in the course of the abovementioned sending step S43, the identifier ID_{LECT} of the reader LECT is transmitted in a manner encrypted using an encryption key associated with a digital certificate CERT_{LECT}.

In a manner known per se, the digital certificates CERT_{MCT} and CERT_{LECT} are issued by a trusted third-party authority and stored respectively in a memory (not shown) accessible to the module MCT in the environment EVF for providing one or more products or services and in the memory MEM₁ of FIG. 2 or in any other suitable memory integrated into the communicating object OC or connected thereto.

A description will now be given, with reference to FIG. 4B, of the abovementioned mutual authentication step S4, according to a second embodiment of the invention. In the example illustrated, the authentication is requested at the initiative of the reader LECT of the communicating object OC. The authentication step S4 then takes place as follows:

In S40′, the reader LECT of the communicating object OC sends, to the transaction control module MCT, via the secure channel established in S0, an authentication request REQ_AUT1′ that comprises an identifier ID_{LECT} of the reader LECT. The sending step S40′ may be executed for example following the receipt S3 of the request REQ_LECT asking whether the communicating object OC contains a reader LECT or at the same time as the sending, to the module MCT, of a confirmation message indicating that the communicating object OC does indeed have a reader LECT.

The module MCT receives the request REQ_AUT1′ in S41′.

In S42′, the module MCT checks whether the received identifier ID_{LECT} is valid. If the received identifier ID_{LECT} is not valid, the authentication fails.

If the received identifier ID_{LECT} is valid, in S43′, the module MCT in turn sends, to the reader LECT, via the secure channel established in S0, an authentication request REQ_AUT2′ that comprises an identifier ID_{MCT} of the module MCT.

The reader LECT receives the request REQ_AUT2′ in S44′.

In S45′, the reader LECT checks whether the received identifier ID_{MCT} is valid. If the received identifier ID_{MCT} is not valid, the authentication fails.

If the received identifier ID_{MCT} is valid, in S46′, mutual authentication between the module MCT and the reader LECT is established, thereby making it possible to constitute a transaction terminal distributed between the environment EVF for providing one or more products or services and the communicating object OC. When the security level of the transaction is low, in step S42′ of checking the identifier ID_{LECT}, the module MCT checks that this identifier belongs to a list of identifiers stored beforehand in a memory (not shown) accessible to the module MCT in the environment EVF for providing one or more products or services. Correspondingly, in step S45′ of checking the identifier ID_{MCT}, the reader LECT checks that this identifier belongs to a list of identifiers stored beforehand, for example in the memory MEM₁ of FIG. 2 or in any other suitable memory integrated into the communicating object OC or connected thereto.

When the security level of the transaction is high, the mutual authentication step S4 uses an encryption mechanism.

To this end:
in the course of the abovementioned sending step S40′, the identifier ID_{LECT} of the reader LECT is transmitted in a manner encrypted using an encryption key associated with a digital certificate CERT′LECT;
in the course of the abovementioned sending step S43′, the identifier ID_{MCT} of the module MCT is transmitted in a manner encrypted using an encryption key associated with a digital certificate CERT′MCT.

In a manner known per se, the digital certificates CERT′LECT and CERT′MCT are issued by a trusted third-party authority and stored respectively in a memory (not shown) accessible to the module MCT in the environment EVF for providing one or more products or services and in the memory MEM₁ of FIG. 2 or in any other suitable memory integrated into the communicating object OC or connected thereto.

### DETAILED DESCRIPTION OF EXEMPLARY APPLICATIONS OF THE INVENTION

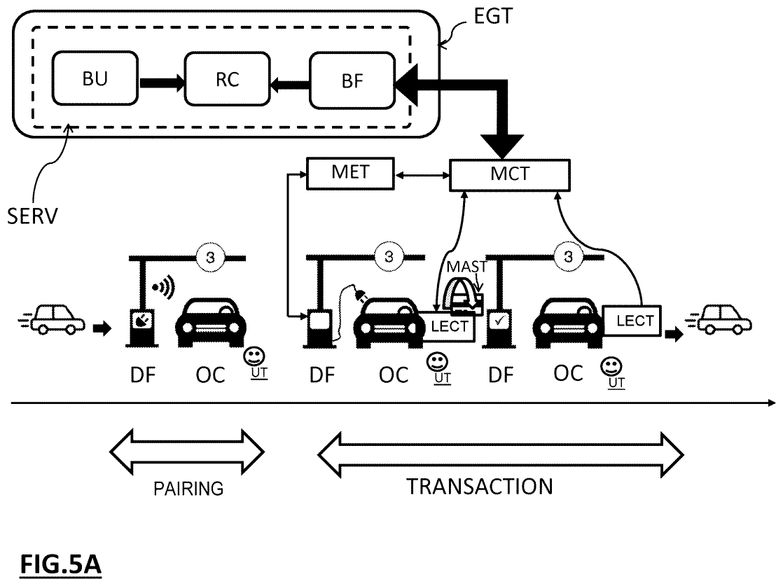

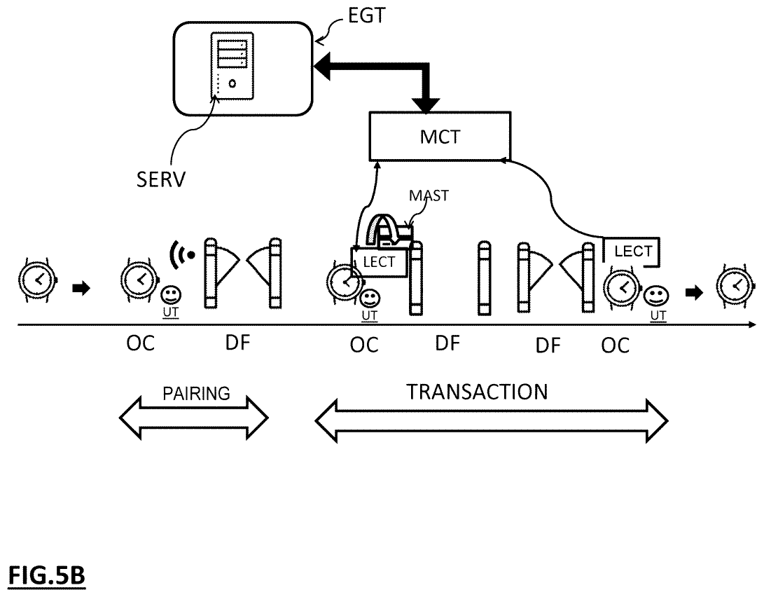

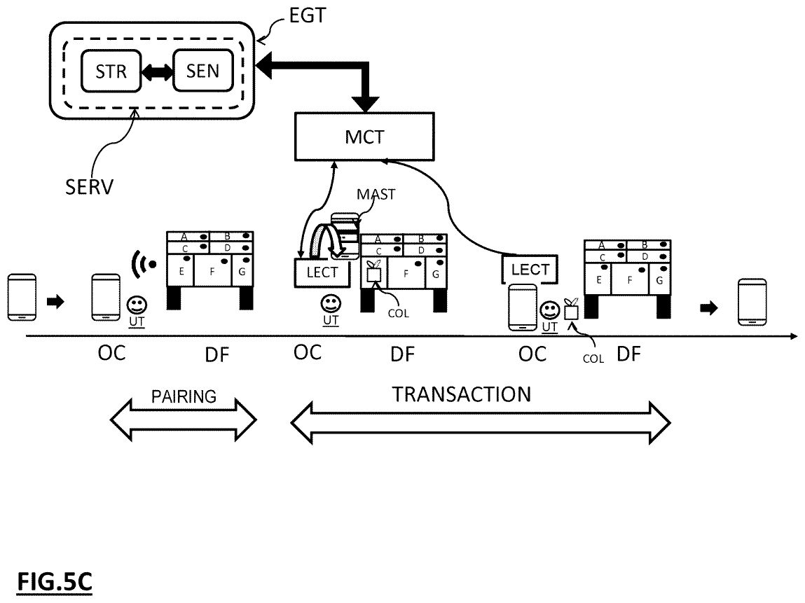

A description will now be given, with reference to FIGS. 5A to 5C, together with FIG. 3, of three different modes of implementation of the method for establishing a transaction as described above.

FIG. 5A shows a system for establishing a transaction according to a first embodiment, for which the transaction is a banking transaction.

In this example, the communicating object OC is for example a vehicle, here a connected electric car. As such, the car OC is natively equipped with a plurality of sensors/detectors, such as for example a camera, a sensor that detects the state of charge of the battery, a speed sensor, a GPS (Global Positioning System) geolocation device, a fingerprint sensor, etc.

According to the invention, the connected car OC is equipped with:
a short-range or medium-range wireless radio communication module COMo, such as for example Bluetooth, LTE, Wi-Fi, DSRC, C-V2X, etc.,
a reader LECT that, in the example shown, is configured to read identification data of a payment card MAST, be this physical or dematerialized.

The reader LECT is housed on board the connected vehicle OC. Its hardware portion HARD is an integral part of the passenger compartment (zone materialized on the dashboard for example), or added to the vehicle (retrofit equipment). The portion HARD may also be an independent equipment provided by the user UT and paired with the vehicle information system. The software portion SOFT is for its part implemented within the computer processing infrastructure deployed in the vehicle (motor vehicle operating system and applications deployed thereon). This infrastructure provides the performance and security compatible with the PCI DSS (Payment Card Industry Data Security Standard).

The reader LECT is able to use the user interface IU of the vehicle information system, for example use the console screen integrated into the dashboard, as well as the entry means offered to the user (touchscreen, dial to interact with the screen, voice control, etc.).

In the example of FIG. 5A, the device DF for providing one or more products or services is one charging terminal among others available in a charging station for electric vehicles. In the example shown, the charging terminal is numbered 3. Of course, this example is in no way exhaustive. In particular, the device DF for providing one or more products or services varies depending on the use context of the connected car OC. To this end, the device DF for providing one or more products or services could be, as an alternative:
a petrol pump,
a take-out food kiosk,
a parking meter,
a toll barrier,
etc.

The charging terminal DF communicates in the environment EVF for providing one or more products or services, via any suitable means of communication, with:
a cash register system MET,
a payment kernel MCT.

The charging terminal DF is also equipped with a short-range or medium-range wireless radio communication module COM_{F}, such as for example Bluetooth, LTE, Wi-Fi, DSRC, C-V2X, etc.

The cash register system MET is configured to record transactions and initiate a payment transaction to the payment kernel MCT.

The payment kernel MCT is connected to the cash register system MET and has external connectivity in order to communicate with the transaction management environment EGT, and in particular with the server BF of the bank of the product or service provider, here the manager of the charging station. This server BF here is part of the transaction management server SERV, the server BF being in communication with the server RC of the bank card network, which itself communicates with the server BU of the bank of the user UT.

This kernel component may be implemented in a virtualized manner, in software form, hosted by a cloud or telecoms operator in a hardware and software environment compatible with the abovementioned PCI DSS standard.

Typically, the payment kernel is of EMV (Europay, Mastercard and Visa) type.

In this context of the establishment of the transaction of the invention, the connected electric car OC starts by pairing, in S0, with the charging terminal DF, via the respective communication modules MCO_{O} and MCO_{F}, in order to establish a secure contactless communication channel to implement the transaction, here a payment corresponding to the charging carried out.

The successful pairing signal is then transmitted to the cash register system MET and to the payment kernel MCT.

The payment kernel MCT and/or the cash register system MET check, in S1, that the charging terminal DF is operational.

In S2, the payment kernel MCT or the charging terminal DF sends, to the connected car OC, via the secure channel established in S0, a request REQ_LECT asking whether the connected car OC contains a reader LECT.

The connected car OC receives the request REQ_LECT in S3.

If the connected car OC contains such a reader LECT, mutual authentication is then executed in S4 between the payment kernel MCT and the reader LECT, so as to emulate an EPT payment terminal.

Step S4 may be followed by a pre-authorization step required by the payment terminal thus emulated. To this end, in S5, the payment kernel MCT or the charging terminal DF sends a request REQ_TR, to the user UT, asking them to present their means of payment MAST, either by way of an acoustic message DAT delivered over a loudspeaker in the car, or by way of a text message DAT that is displayed on the screen of the console.

The connected car OC receives the request REQ_TR in S6.

In S7, the user interface IU is then activated in order to ask the user UT to present their payment card MAST to the reader LECT.

The reader LECT then, in S8, reads identification data ID_{MAST} of the payment card MAST.

In the case where the payment card MAST is a contactless chip card, for example an NFC chip card, the user UT, in S8, brings their card toward the NFC surface of the reader LECT. In order to increase the security level of the transaction, the user UT may be asked to enter a secret code MP on the keypad of the console of the car OC.

In the case where the chip payment card MAST is not contactless, the user UT inserts it into a dedicated opening in the reader LECT and enters their secret code MP on the keypad of the console.

In the case where the payment card MAST is virtualized, such reading S8 is implemented following access, via the access module ACC of FIG. 2, to the virtualized payment card MAST, in the memory MEM₁ of the connected car OC. If there are multiple virtualized cards in memory, the access is executed following selection, by the user UT, of the virtualized card to be used for the transaction.

In S9, the connected car OC transmits the identification data ID_{MAST} to the payment kernel MCT via the secure channel established in SO.

The payment kernel makes the pre-authorization request to the server BU of the bank of the user UT. This request is processed in a conventional manner, that is to say the request is routed from the server BF of the bank of the service station, via the bank card network server RC, to the server BU of the bank of the user UT.

In the case where the authorization is validated, the payment kernel MCT transmits a signal to the charging terminal DF to authorize it to supply electricity to the connected car OC.

Once refueling is complete, the payment kernel MCT or the charging terminal DF communicates the amount DAT to be debited to the connected car OC, via the secure channel established in SO.

The payment kernel MCT carries out the debit in S10 via the servers BU, RC and BF, and then transmits the end of transaction information to the reader LECT for display on the screen of the connected car OC or to be listened to via the one or more loudspeakers of the connected car OC.

FIG. 5B shows a system for establishing a transaction according to a second embodiment of the invention, for which the transaction is that of controlling access to a secure or non-secure premises, a means of transport, etc. This second embodiment uses elements in common with those of FIG. 5A. For this reason, these elements are designated with the same references.

In this example, the communicating object OC is for example an object carried or worn by the user UT, such as for example a connected watch. It could of course be a tablet, a badge, a bracelet, glasses, etc.

As such, the watch OC is natively equipped with a plurality of sensors/detectors, such as for example a camera, a photographic camera, an accelerometer, a GPS geolocation device, a fingerprint sensor, etc.

According to the invention, the connected watch OC is equipped with:
a short-range or medium-range wireless radio communication module COMo, such as for example Bluetooth, LTE, Wi-Fi, DSRC, C-V2X, etc.,
a reader LECT that, in the example shown, is configured to read identification data of a transport badge MAST, be this physical or dematerialized.

The reader LECT is associated with the connected watch OC. Its hardware portion HARD is an integral part of the casing of the watch OC or is connected thereto. The software portion SOFT is for its part implemented within the operating system of the watch OC.

The reader LECT is able to use the user interface IU of the watch (keypad, screen, loudspeaker, haptic (vibrations)).

In the example of FIG. 5B, the device DF for providing one or more products or services is an access gate to a means of transport, such as for example the metro, the train, the tram, etc. It may also be a terminal arranged on a bus or a tram, near a platform in a railway station, etc.

The gate DF communicates in the environment EVF for providing one or more products or services, via any suitable means of communication, with:
a transaction recording and processing system MET,
an access control server MCT.

The gate DF is also equipped with a short-range or medium-range wireless radio communication module COM_{F}, such as for example Bluetooth, LTE, Wi-Fi, DSRC, C-V2X, etc.

The transaction recording and processing system MET is configured to record transactions and initiate an access operation to the access control server MCT.

The access control server MCT is connected to the transaction recording and processing system MET and has external connectivity in order to communicate with the transaction management environment EGT, and in particular with a transaction management server SERV that is held, for example, by a transport control agency.

In this context of the establishment of the transaction of the invention, the connected watch OC starts by pairing, in S0, with the gate DF, via the respective communication modules MCO_{O} and MCO_{F}, in order to establish a secure contactless communication channel to implement the transaction, here accessing public transport.

The successful pairing signal is then transmitted to the transaction recording and processing system MET and to the access control server MCT.

The access control server MCT and/or the transaction recording and processing system MET check, in S1, that the gate DF is operational.

In S2, the access control server MCT or the gate DF sends, to the connected watch OC, via the secure channel established in S0, a request REQ_LECT asking whether the connected watch OC contains a reader LECT.

The connected watch OC receives the request REQ_LECT in S3.

If the connected watch OC contains such a reader LECT, mutual authentication in accordance with the invention is then executed in S4 between the access control server MCT and the reader LECT, so as to emulate an access control terminal.

In S5, the access control server MCT or the gate DF sends a request REQ_TR to the user UT, asking them to present their transport badge MAST, either by way of an acoustic message DAT delivered over the loudspeaker of the watch OC, or by way of a text message DAT that is displayed on the screen of the watch. In addition or as an alternative, the data DAT may contain the type of transaction, for example an identifier of the transport line and/or a number of tickets to be validated.

The connected watch OC receives the request REQ_TR in S6.

In S7, the user interface IU is then activated in order to ask the user UT to present their transport badge MAST to the reader LECT.

The reader LECT then, in S8, reads identification data ID_{MAST} of the transport badge MAST.

In the case where the transport badge MAST is a contactless chip card, for example an NFC chip card, the user UT, in S8, brings their badge toward the NFC surface of the reader LECT. In order to increase the security level of the transaction, the user UT may be asked to enter a secret code MP on the keypad of the connected watch OC.

In the case where the transport badge MAST is dematerialized, such reading S8 is implemented following access, via the access module ACC of FIG. 2, to the badge MAST, in the memory MEM₁ of the watch OC. If there are multiple transport badges in memory, the access is executed following selection, by the user UT, of the badge to be used to access the means of transport.

In S9, the watch OC transmits the identifier ID_{MAST} of the badge MAST to the access control server MCT via the secure channel established in SO.

In S10, the access control server MCT decrements one or more digital transport tickets preloaded in the transport badge MAST or in the memory MEM₁ of the connected watch OC when the badge MAST is in dematerialized form. As a variant, in the case of a subscription to the means of transport, the access control server MCT checks, in S10, with the management server SERV that the identifier ID_{MAST} of the badge MAST is indeed valid. In this case, the access control server MCT commands the opening of the gate DF to let the user UT through, then commands closure thereof after a predetermined duration. The transaction is then recorded in the transaction recording system MET, which communicates the information in relation to this transaction to the server SERV. The access control server MCT transmits the end of transaction information, for example the number of tickets used, to the reader LECT for display on the screen of the connected watch OC or to be listened to via the one or more loudspeakers of the connected watch OC. FIG. 5C shows a system for establishing a transaction according to a third embodiment of the invention, for which the transaction is a command to open/close a locker of an automatic parcel collection locker unit, terminal or cabinet. This third embodiment uses elements in common with those of FIGS. 5A and 5B. For this reason, these elements are designated with the same references.

In this example, the communicating object OC is for example an object carried or worn by the user UT, such as for example a smartphone. It could of course, as a variant, be a tablet, a badge, a bracelet, etc.

As such, the smartphone OC is natively equipped with a plurality of sensors/detectors, such as for example a camera, a photographic camera, an accelerometer, a GPS geolocation device, a fingerprint sensor, etc.

According to the invention, the smartphone OC is equipped with:
a short-range or medium-range wireless radio communication module COMo, such as for example Bluetooth, LTE, Wi-Fi, DSRC, C-V2X, etc.,
a reader LECT that, in the example shown, is configured to read identification data of a collection label MAST of a parcel COL, such as for example a barcode or QR (Quick Response) code that was transmitted beforehand to the smartphone OC by the brand that sold the goods contained in the parcel or by the carrier that delivered the parcel. As an alternative, the label MAST could be a physical label available to the user UT and carrying the abovementioned barcode or QR code.

The hardware portion HARD of the reader LECT is an integral part of the smartphone OC. As a variant, the hardware portion HARD may be equipment that the user UT connects beforehand to the smartphone OC, via a wired link or a wireless connection. The software portion SOFT of the reader LECT is for its part implemented within the operating system of the smartphone OC.

The reader LECT is able to use the user interface IU of the smartphone OC (keypad, screen, loudspeaker).

In the example of FIG. 5C, the device DF for providing one or more products or services is an automatic parcel collection locker unit. In the example shown, this locker unit comprises seven lockers referenced A to G.

The collection locker unit DF communicates in the environment EVF for providing one or more products or services, via any suitable means of communication, with:
a transaction recording and processing system MET,
a server MCT for commanding opening/closure of a locker.

The collection locker unit DF is also equipped with a short-range or medium-range wireless radio communication module COM_{F}, such as for example Bluetooth, LTE, Wi-Fi, DSRC, C-V2X, etc.

The transaction recording system MET is configured to record transactions, here parcel collections, and initiate a parcel collection operation to the server MCT for commanding the opening/closure of a locker.

The server MCT for commanding the opening/closure of a locker is connected to the transaction recording and processing system MET and has external connectivity in order to communicate with the transaction management environment EGT, and in particular with a transaction management server SERV that comprises a management server SEN belonging to the brand that sold the goods contained in the parcel COL, which server SEN communicates with a management server STR belonging to the carrier that delivered the parcel to the collection locker unit DF. In this context of the establishment of the transaction of the invention, when the user UT approaches the collection locker unit DF, the smartphone OC starts by pairing, in S0, with the collection locker unit DF, via the respective communication modules MCO_{O} and MCO_{F}, in order to establish a secure contactless communication channel to implement the transaction, here a command to open/close a locker.

The successful pairing signal is then transmitted to the transaction recording and processing system MET and to the server MCT for commanding the opening/closure of the locker E containing the parcel COL to be collected.

The server MCT for commanding the opening/closure of a locker and/or the transaction recording and processing system MET check, in S1, that the collection locker unit DF is operational.

In S2, the server MCT for commanding the opening/closure of a locker or the collection locker unit DF sends, to the smartphone OC, via the secure channel established in S0, a request REQ_LECT asking whether the smartphone OC contains a reader LECT.

The smartphone OC receives the request REQ_LECT in S3.

If the smartphone OC contains such a reader LECT, mutual authentication in accordance with the invention is then executed in S4 between the server MCT and the reader LECT, so as to emulate a terminal for commanding opening or closure of a locker.

In S5, the server MCT or the collection locker unit DF sends a request REQ_TR to the user UT asking them to present their collection label MAST, either by way of an acoustic message DAT delivered over the loudspeaker of the smartphone OC, or by way of a text message DAT that is displayed on the screen of the smartphone. In addition or as an alternative, the data DAT may contain an identifier, a logo or a name of the brand of the shop from which the parcel COL originates, the price of the order, an identifier of the locker that contains the parcel COL, etc.

In S7, the user interface IU is then activated in order to ask the user UT to present their collection label MAST to the reader LECT.

The reader LECT then, in S8, reads identification data ID_{MAST} of the label MAST, in this case the barcode or QR code.

In the case where the label MAST is a physical medium, for example a sheet of paper, a sticker or the like, the user UT, in S8, brings the label MAST toward the surface of the reader LECT, which is designed to read such codes.

In the case where the label MAST has been transmitted to the smartphone OC, such reading S8 is implemented following access, via the access module ACC of FIG. 2, to the label MAST, in the memory MEM₁ of the smartphone OC. If there are multiple labels stored in memory, the access is executed following selection, by the user UT, of the label MAST to be read.

In S9, the smartphone OC transmits the identifier ID_{MAST} of the label MAST to the server MCT via the secure channel established in SO.

In S10, the server MCT checks with the server STR of the carrier that the identifier ID_{MAST} of the label MAST is indeed valid. If this identifier is valid, the server MCT commands the opening of one of the lockers that contains the parcel COL, locker E in the example shown, and then, once locker E has been emptied, commands closure thereof after a predetermined duration. The transaction is then recorded in the transaction recording and processing system MET, which communicates the information in relation to this transaction to the servers SEN and STR. The access control server MCT transmits the end of transaction information, for example the number of parcels collected, to the reader LECT for display on the screen of the smartphone OC or to be listened to via the one or more loudspeakers of the smartphone OC.

1. A method comprising:
establishing a transaction using a communicating object in order to implement provision of a product or service to a user, in the course of which the communicating object receives a request containing data relating to the transaction from a device for providing the product or service or from a transaction control module associated with said device, wherein the communicating object implements the following:
receiving, from said transaction control module or from said device, a message asking whether a reader for reading a means of access to a service implementing said transaction is associated with the communicating object;
in response to a reader being associated with the communicating object, reading identification data of a means of access to said service, using said reader; and
transmitting the read identification data to the transaction control module in order to validate the transaction.

2. The method for establishing a transaction as claimed in claim 1, wherein, before said reading, the method implements a step of mutual authentication between the reader associated with the communicating object and the transaction control module.

3. The method for establishing a transaction as claimed in claim 2, comprising the following, at the reader associated with the communicating object, during execution of said step of mutual authentication:
receiving, from the transaction control module, an identifier of said transaction control module,
checking validity of said identifier,
in response to said identifier being valid, transmitting an identifier of said reader to the transaction control module,
in response to the identifier of said reader having been recognized as valid by the transaction control module, mutually authenticating the reader and the transaction control module.

4. The method for establishing a transaction as claimed in claim 2, comprising the following, at the reader associated with the communicating object, during execution of said step of mutual authentication:
transmitting an identifier of said reader to the transaction control module,
in response to the identifier of said reader having been recognized as valid by the transaction control module, receiving, from said transaction control module, a message containing an identifier of said transaction control module,
checking validity of the identifier of said transaction control module,
in response to the identifier of said transaction control module being valid, mutually authenticating the reader and the transaction control module.

5. The method for establishing a transaction as claimed in claim 2, wherein an identifier of the reader as well as an identifier of the transaction control module are transmitted using an encryption mechanism.

6. A communicating object for establishing a transaction implementing provision of a product or service to a user, said communicating object comprising:
a processor that is configured to receive a request containing data relating to the transaction from a device for providing the product or service or from a transaction control module associated with said device, wherein the processor of the communicating object implements the following:
receiving, from said transaction control module or from said device, a message asking whether a reader for reading a means of access to a service implementing said transaction is associated with the communicating object;
in response to a reader being associated with the communicating object, reading identification data of a means of access to said service, using said reader; and
transmitting the read identification data to the transaction control module in order to validate the transaction.

7. (canceled)

8. A non-transitory computer-readable information medium comprising instructions of a computer program stored thereon which when executed by a processor of a communicating object configure the communicating object to implement a method comprising:
establishing a transaction using the communicating object in order to implement provision of a product or service to a user, in the course of which the communicating object receives a request containing data relating to the transaction from a device for providing the product or service or from a transaction control module associated with said device, wherein the communicating object implements the following:
receiving, from said transaction control module or from said device, a message asking whether a reader for reading a means of access to a service implementing said transaction is associated with the communicating object;
in response to a reader being associated with the communicating object, reading identification data of a means of access to said service, using said reader; and
transmitting the read identification data to the transaction control module in order to validate the transaction.

9. (canceled)
